(19) United States
(12) Patent Application Publication
(10) Pub. No.: US 2024/0408594 A1
(43) Pub. Date: Dec. 12, 2024

(54) MICROFLUIDIC CHIP AND MICROFLUIDIC CHIP DETECTION SYSTEM

(71) Applicants: XIAMEN UNIVERSITY, Xiamen (CN); XIAMEN INNODX BIOTECH CO., LTD, Xiamen (CN)

(72) Inventors: Dongxu ZHANG, Xiamen (CN); Runxin GAO, Xiamen (CN); Shaolei HUANG, Xiamen (CN); Yulin HUANG, Xiamen (CN); Guoqiang LIU, Xiamen (CN); Jiayu YANG, Xiamen (CN); Juntian ZENG, Xiamen (CN); Liuwei SONG, Xiamen (CN); Shengxiang GE, Xiamen (CN); Jun ZHANG, Xiamen (CN); Ningshao XIA, Xiamen (CN)

(73) Assignees: XIAMEN UNIVERSITY, Xiamen (CN); XIAMEN INNODX BIOTECH CO., LTD, Xiamen (CN)

(21) Appl. No.: 18/697,740

(22) PCT Filed: Nov. 11, 2022
(86) PCT No.: PCT/CN2022/131391

§ 371 Date: Apr. 2, 2024

(30) Foreign Application Priority Data
Nov. 17, 2021 (CN) 202111362356.6

(51) Int. Cl. B01L 3/00; B01L 7/00

(52) U.S. Cl. CPC B01L 3/502715; B01L 7/52; B01L 2200/16; B01L 2300/0663; B01L 2300/0832; B01L 2300/18; B01L 2400/0622

(57) ABSTRACT

The present disclosure relates to a microfluidic chip and a microfluidic chip detection system. The microfluidic chip including: a storage member provided with a groove therein, at least two storage chambers being disposed around the groove; a base disposed at one end of the storage member away from the groove, a reaction chamber being disposed on the base; and a valve disposed in the groove, the valve being configured to operatively communicate any one of the at least two storage chambers with the reaction chamber. The present disclosure can lead the solution in any storage chamber to the reaction chamber or lead the solution in the reaction chamber to any storage chamber by operating the valve, so that the solution transfer is realized, the structure is simple and compact, the length of the flow channels can be greatly shortened, and the detection efficiency is improved.

### CROSS-REFERENCE TO RELATED APPLICATIONS

This present disclosure is based on and claims priority to Chinese Patent Application No. 202111362356.6, filed on Nov. 17, 2021, which is hereby incorporated by reference in its entirety.

### TECHNICAL FIELD

The present disclosure relates to the field of in vitro diagnosis, in particular to a microfluidic chip and a microfluidic chip detection system.

### BACKGROUND

The nucleic acid detection technology is a technology that directly detects the genetic materials of living organisms, such as DNA and RNA, and has ultra high specificity and sensitivity, short window period and multiple detection capabilities. However, the nucleic acid detection process is very complicated and has numerous steps and very high requirements on detection environment, laboratory conditions and technical level of personnel. Therefore, the development trend of nucleic acid detection is full-automatic integration, high integration, bedside detection, instant detection and random inspection at random place.

In order to realize the above automatic integrated detection of nucleic acids, a microfluidic technology has emerged in recent years, and integrates complicated nucleic acid detection processes on chips having micro-sized flow channels and cavities and arranged in a certain rule, different biochemical reagents are released in a certain order, and flow to designated cavities through different flow channels to complete various biochemical reactions, and finally rapid and accurate detection of the nucleic acids is realized. Benefiting from such a realizing form, the nucleic acid detection based on the microfluidic technology has the advantages such as complete automation, high integration, simplicity and rapidity, avoidance of cross-contamination, capability of independent use in various environments and no need of highly specialized personnel, which meets the concept and requirements of rapid detection.

### SUMMARY

In one aspect of the present disclosure, there is provided a microfluidic chip, including:
a storage member provided with a groove therein, at least two storage chambers being disposed around the groove;
a base disposed at one end of the storage member away from the groove, a reaction chamber being disposed on the base; and
a valve disposed in the groove, the valve being configured to operatively communicate any one of the at least two storage chambers with the reaction chamber.

In some embodiments, at least two first storage member inner flow channels are disposed in the storage member, each first storage member inner flow channel is correspondingly communicated with one storage chamber, a valve inner flow channel communicated with the reaction chamber is disposed in the valve, and the valve is configured to operatively communicate the valve inner flow channel with any first storage member inner flow channel.

In some embodiments, a first end of each first storage member inner flow channel penetrates a bottom wall of the groove, the valve is configured to operatively communicate the valve inner flow channel with the first end of the first storage member inner flow channel, and a second end of each first storage member inner flow channel is communicated with the storage chamber via one side of the storage chamber adjacent to the base.

In some embodiments, the second ends of the first storage member inner flow channels are communicated with the parts of the storage chambers at the lowest positions.

In some embodiments, both a first end and a second end of the valve inner flow channel penetrate one end of the valve adjacent to the bottom wall of the groove, the first end of the valve inner flow channel is communicated with the reaction chamber, the second end of the valve inner flow channel is operatively communicated with any first storage member inner flow channel, the first end of the valve inner flow channel is located in a middle of the valve, and the second end of the valve inner flow channel is close to an outer edge of the valve.

In some embodiments, the valve includes:
a rotor rotatably disposed in the groove, the rotor includes a valve seat and a valve stem, and the valve stem being connected with the valve seat; and
a valve cover connected with a circumferential side wall of the groove and abutting against the valve seat to limit the valve seat between the valve cover and the bottom wall of the groove, the valve cover being provided with a first through hole, an operating part of the valve stem penetrating the first through hole, and the operating part of the valve stem being configured to be connected with an external operating member.

In some embodiments, the valve cover abuts against a circumferential edge of the valve seat.

In some embodiments, the microfluidic chip further includes a sealing film, the at least two storage chambers include a reagent chamber, the sealing film is configured to seal the reagent chamber, the microfluidic chip further includes a top cover and a puncture needle, the top cover is disposed at one end of the storage member provided with the groove, the puncture needle is connected to the top cover, and the puncture needle is configured to press against the sealing film under the action of an external force to puncture the sealing film.

In some embodiments, the top cover includes a first rib, the puncture needle is connected to the first rib, and the first rib is configured to be disconnected under the action of the external force, so that the puncture needle is separated from the top cover and pressed against the sealing film.

In some embodiments, a middle of the top cover is provided with a second through hole, and the second through hole is configured to allow the external operating member to penetrate to operate the valve.

In some embodiments, the puncture needle is provided with a needle inner gas channel therein, and a third through hole communicating an outer part of the puncture needle with the needle inner gas channel is disposed near a part of the puncture needle connected with the top cover.

In some embodiments, the microfluidic chip further includes a cover sheet, the cover sheet is disposed in the top cover, the cover sheet is provided with a fourth through hole allowing the puncture needle to penetrate, and the puncture needle is configured to press against the sealing film under the action of the external force, and continue to press against the sealing film after puncturing the sealing film, so that the third through hole is sealed by the cover sheet.

In some embodiments, the reaction chamber protrudes towards one side away from the storage member.

In some embodiments, the reaction chamber has a spherical crown structure.

In some embodiments, the microfluidic chip further includes an amplification member, the amplification member is provided with an amplification chamber, a side part of the storage member is provided with a slot, the slot is located between two adjacent storage chambers, the amplification member is connected with the slot in an inserting way, and the valve is configured to operatively communicate the reaction chamber with the amplification chamber.

In some embodiments, the storage member is provided with a second storage member inner flow channel, a first end of the second storage member inner flow channel penetrates the slot, a second end of the second storage member inner flow channel penetrates the groove, the amplification member is provided with an amplification member inner flow channel communicated with the amplification chamber, the amplification member inner flow channel is communicated with the first end of the second storage member inner flow channel, and the valve is configured to be operatively communicated with the second end of the second storage member inner flow channel to guide a solution in the reaction chamber to the amplification chamber through the second storage member inner flow channel and the amplification member inner flow channel.

In some embodiments, the storage member is provided with a third storage member inner flow channel, a first end of the third storage member inner flow channel penetrates the slot, a second end of the third storage member inner flow channel penetrates the groove, the amplification member is provided with an amplification member inner gas channel communicated with the amplification chamber, the amplification member inner gas channel is communicated with the first end of the third storage member inner flow channel, and the valve is configured to be operatively communicated with the second end of the third storage member inner flow channel to guide gas in the amplification chamber to one storage chamber through the amplification member inner gas channel and the third storage member inner flow channel.

In some embodiments, the valve inner flow channel communicated with the reaction chamber is disposed in the valve, a valve inner gas channel is also disposed in the valve, and the valve is configured to operatively communicate the valve inner flow channel with the reaction chamber and the amplification chamber, and communicate the valve inner gas channel with the amplification chamber and one storage chamber.

In some embodiments, the storage member is provided with a storage member inner gas channel, the storage member inner gas channel is communicated with the reaction chamber, and the storage member inner gas channel is configured to be communicated with an external air pump.

In some embodiments, a first end of the storage member inner gas channel penetrates one end of the storage member provided with the groove, and the first end of the storage member inner gas channel is located between two adjacent storage chambers.

In some embodiments, the top cover is fixedly disposed at one end of the storage member provided with the groove, and the base is fixedly disposed at one end of the storage member away from the top cover.

In one aspect of the present disclosure, there is provided a microfluidic chip detection system, including a detection device and the above microfluidic chip, Wherein the detection device includes an operating table for accommodating the microfluidic chip and an operating member for operating the valve.

Based on the above technical solution, the present disclosure at least has the following beneficial effects:

In some embodiments, the storage member is provided with the groove, at least two storage chambers are disposed around the circumferential direction of the groove, the valve is disposed in the groove, and the reaction chamber is disposed below the valve. By operating the valve, the solution in any storage chamber can be introduced to the reaction chamber or the solution in the reaction chamber can be introduced to any storage chamber, so that the solution transfer is realized, the structure is simple and compact, the length of the flow channels can be greatly shortened, and the detection efficiency is improved.

### BRIEF DESCRIPTION OF THE DRAWINGS

The accompanying drawings described herein are used to provide a further understanding of the present disclosure and form a part of the present application. The exemplary embodiments of the present disclosure and their descriptions are used to explain the present disclosure and do not form an improper limitation to the present disclosure. In the drawings:

FIG. 1 is a schematic diagram of an overall structure of a microfluidic chip provided according to some embodiments of the present disclosure;

FIG. 2 is a schematic diagram of an exploded structure of a microfluidic chip provided according to some embodiments of the present disclosure;

FIG. 3 is a schematic structural diagram of a top cover of a microfluidic chip provided according to some embodiments of the present disclosure;

FIG. 4 is a structural schematic diagram of a top cover and a cover sheet of a microfluidic chip provided according to some embodiments of the present disclosure;

FIG. 5 is a structural schematic diagram of a storage member and a valve of a microfluidic chip provided according to some embodiments of the present disclosure;

FIG. 6 is a schematic top view of a storage member of a microfluidic chip provided according to some embodiments of the present disclosure;

FIG. 7 is a schematic bottom view of a storage member of a microfluidic chip provided according to some embodiments of the present disclosure;

FIG. 8 is a schematic sectional view of a storage member of a microfluidic chip provided according to some embodiments of the present disclosure;

FIG. 9 is a schematic diagram of an exploded structure of a valve of a microfluidic chip provided according to some embodiments of the present disclosure;

FIG. 10 is a schematic sectional view of a valve of a microfluidic chip provided according to some embodiments of the present disclosure;

FIG. 11 is a structural schematic diagram of a base of a microfluidic chip provided according to some embodiments of the present disclosure;

FIG. 12 is a schematic top view of a base of a microfluidic chip provided according to some embodiments of the present disclosure;

FIG. 13 is a schematic diagram of a bottom structure of a base of a microfluidic chip provided according to some embodiments of the present disclosure;

FIG. 14 is a schematic sectional view of a base of a microfluidic chip provided according to some embodiments of the present disclosure;

FIG. 15 is a schematic diagram of an amplification member of a microfluidic chip provided according to some embodiments of the present disclosure;

FIG. 16 is a schematic diagram before connection of an amplification member, a second gasket and a storage member of a microfluidic chip provided according to some embodiments of the present disclosure; and

FIG. 17 is a schematic diagram before insertion of an amplification member into a slot of a storage member of a microfluidic chip provided according to some embodiments of the present disclosure.

### DETAILED DESCRIPTION OF THE EMBODIMENTS

The technical solutions in the embodiments will be clearly and completely described below in combination with the accompanying drawings in the embodiments of the present disclosure. Obviously, the described embodiments are only a part but not all of the embodiments of the present disclosure. Based on the embodiments of the present disclosure, all other embodiments obtained by those ordinary skilled in the art without creative work are within the protection scope of the present disclosure.

In the description of the present disclosure, it should be understood that the orientation or positional relationships indicated by terms such as “center”, “longitudinal”, “lateral”, “front”, “rear”, “left”, “right”, “vertical”, “horizontal”, “top”, “bottom”, “inner” and “outer” are based on the orientation or positional relationships shown in the drawings, only for the purposes of the ease in describing the present disclosure and simplification of its descriptions, but not indicating or implying that the specified device or element must be specifically located, and structured and operated in a specific direction, and therefore, should not be understood as limitations to the protective scope of the present disclosure.

Some embodiments of the present disclosure provide a microfluidic chip and a microfluidic chip detection system, which are suitable for rapid in vitro detection.

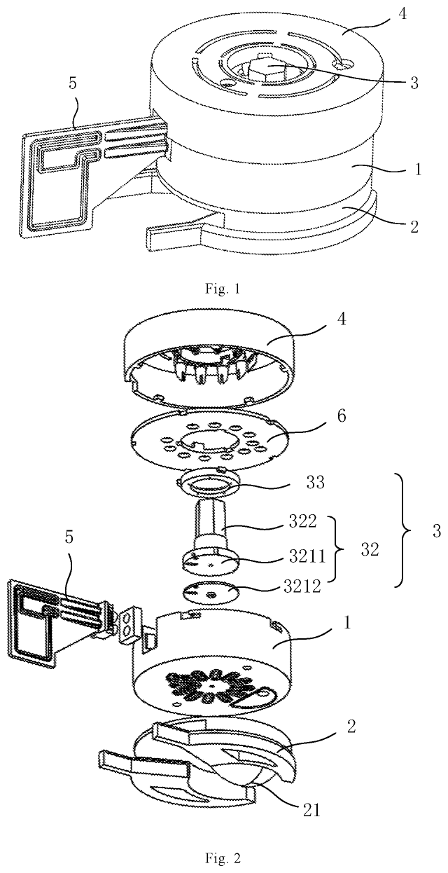

As shown in FIGS. 1 and 2, some embodiments provide a microfluidic chip, including a storage member 1, a base 2 and a valve 3.

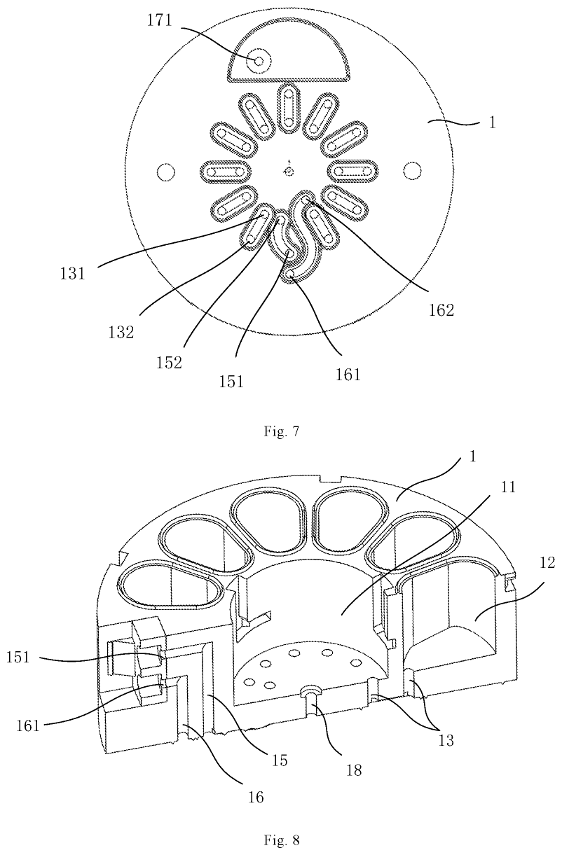

As shown in FIGS. 5 and 6, the storage member 1 is provided with a groove 11 therein, and at least two storage chambers 12 are disposed around the groove 11. The groove 11 includes a bottom wall and a circumferential side wall.

As shown in FIGS. 1 and 2, the base 2 is disposed at one end of the storage member 1 away from the groove 11, and a reaction chamber 21 is disposed on the base 2.

As shown in FIGS. 1, 2 and 5, the valve 3 is disposed in the groove 11, and the valve 3 is configured to operatively communicate any one of the at least two storage chambers 12 with the reaction chamber 21.

At least two storage chambers 12 include at least one sample chamber and at least two reagent chambers 121. The reagent chambers 121 are used to store different detection reagents, which may be solid or liquid reagents, and the number of the reagent chambers 121 may be flexibly increased or decreased as required. One sample chamber may be disposed, or two may be set disposed as required. The sample chamber is used to add a sample to be detected, including blood or saliva, etc.

The reaction chamber 21 is a reagent reaction place for nucleic acid extraction.

The valve 3 is a key component for fluid flow control in the microfluidic chip, and controls the communication and closure of flow channels.

The base 2 is used to ensure that the microfluidic chip is stably laid flat, and has the functions of positioning and limiting, so as to improve detection stability.

According to the embodiments of the present disclosure, the groove 11 is disposed in the storage member 1, at least two storage chambers 12 are disposed around the circumferential direction of the groove 11, the valve 3 is disposed in the groove 11, and the reaction chamber 21 is disposed below the valve 3. By operating the valve 3, the solution in any storage chamber 12 can be introduced to the reaction chamber 21, or the solution in the reaction chamber 21 can be introduced to any storage chamber 12, so that solution transfer is realized, the structure is simple and compact, the length of the flow channels can be greatly shortened, and the detection efficiency is improved.

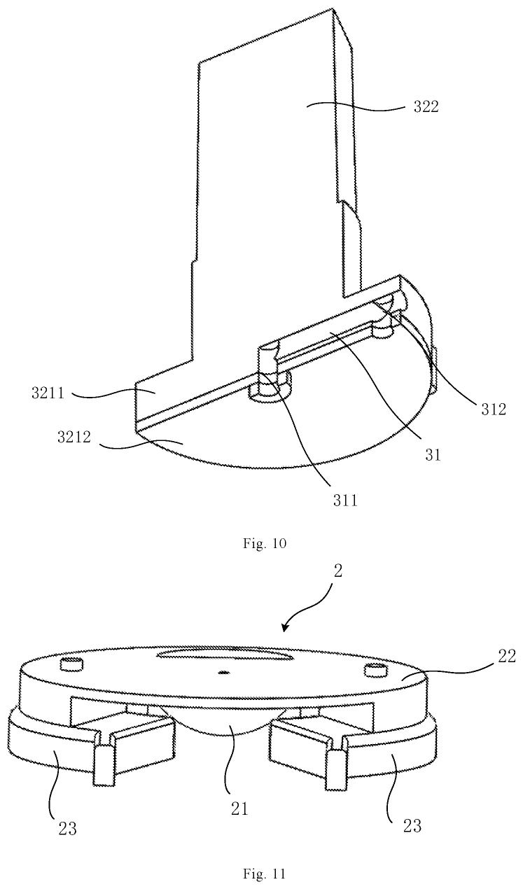

As shown in FIG. 8, at least two first storage member inner flow channels 13 are disposed in the storage member 1, and each first storage member inner flow channel 13 is correspondingly communicated with one storage chamber 12. As shown in FIG. 10, a valve inner flow channel 31 communicated with the reaction chamber 21 is disposed in the valve 3, and the valve 3 is configured to operatively communicate the valve inner flow channel 31 with any one first storage member inner flow channel 13.

The valve inner flow channel 31 is always communicated with the reaction chamber 21. By operating the valve 3, the valve inner flow channel 31 is selectively communicated with any one first storage member inner flow channel 13, so as to introduce the solution in the storage chamber 12 to the reaction chamber 21 or the solution in the reaction chamber 21 to the storage chamber 12.

In some embodiments, as shown in FIGS. 6 to 8, a first end 131 of each first storage member inner flow channel 13 penetrates the bottom wall of the groove 11, the valve 3 is configured to operatively communicate the valve inner flow channel 31 with the first end 131 of the first storage member inner flow channel 13, and a second end 132 of each first storage member inner flow channel 13 is communicated with the storage chamber 12 via one side of the storage chamber 12 adjacent to the base 2.

In some embodiments, as shown in FIGS. 6 to 8, the second ends 132 of the first storage member inner flow channels 13 are communicated with the parts of the storage chambers 12 at the lowest positions and closest to the groove 11.

In some embodiments, as shown in FIGS. 6 to 8, the second ends 132 of the first storage member inner flow channels 13 are communicated with the parts of the storage chambers 12 at the lowest positions and closest to the groove 11, so as to shorten the length of the flow channel.

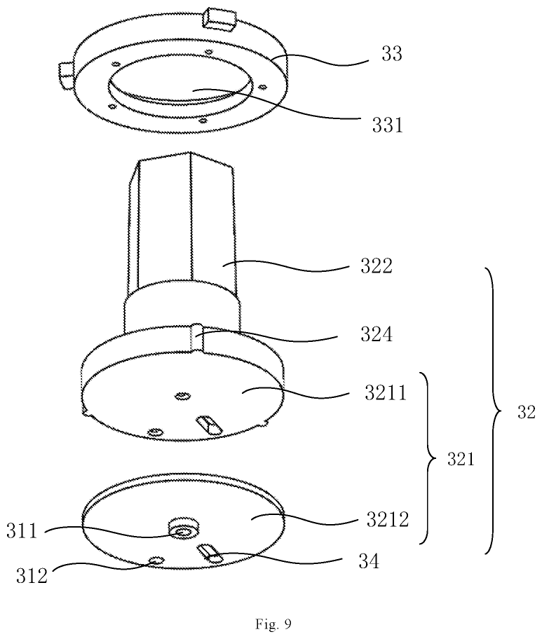

In some embodiments, as shown in FIGS. 9 and 10, both a first end 311 and a second end 312 of the valve inner flow channel 31 penetrate one end of the valve 3 adjacent to the bottom wall of the groove 11, the first end 311 of the valve inner flow channel 31 is communicated with the reaction chamber 21, the second end 312 of the valve inner flow channel 31 is operatively communicated with any one first storage member inner flow channel 13, the first end 311 of the valve inner flow channel 31 is located in the middle of the valve 3, and the second end 312 of the valve inner flow channel 31 is close to the outer edge of the valve 3.

In some embodiments, as shown in FIGS. 5 and 8, the storage member 1 is cylindrical as a whole.

In some embodiments, as shown in FIGS. 2, 9 and 10, the valve 3 includes a rotor 32 and a valve cover 33.

The rotor 32 is rotatably disposed in the groove 11. The rotor 32 includes a valve seat 321 and a valve stem 322, and the valve stem 322 is connected with the valve seat 321.

The valve cover 33 is connected with the circumferential side wall of the groove 11 and abuts against the valve seat 321, the valve seat 321 is limited between the valve cover 33 and the bottom wall of the groove 11, and the valve seat 321 abuts against the bottom wall of the groove 11. The valve cover 33 is provided with a first through hole 331, an operating part of the valve stem 322 penetrates the first through hole 331, and the operating part of the valve stem 322 is configured to be connected with an external operating member.

The valve seat 321 includes a valve seat body 3211 and a first gasket 3212, the first gasket 3212 is consistent with the bottom of the valve seat body 3211 in shape, and the valve seat body 3211 and the first gasket 3212 are fixedly disposed. The valve inner flow channel 31 is formed in the valve seat 321. The valve seat body 3211 is made of a hard material, and the first gasket 3212 is made of an elastic material. An appropriate abutting pressure is applied to the valve seat 321 of the rotor 32 by adjusting the valve cover 33, so that the valve seat 321 abuts against the bottom wall of the groove 11, further the valve inner flow channel 31 has the air tightness required by detection, and liquid leakage at the joint between the valve inner flow channel 31 and the storage member inner flow channel is avoided.

In some embodiments, the valve cover 33 abuts against a circumferential edge of the valve seat 321.

The first end 131 of each first storage member inner flow channel 13 penetrates the bottom wall of the groove 11 and is disposed around a central axis of the groove 11, and the valve cover 33 abuts against the circumferential edge of the valve seat 321, so that the valve seat 321 can abut against the bottom wall of the groove 11, and the joint between the valve inner flow channel 31 and the storage member inner flow channel is sealed to avoid liquid leakage.

A radial size of the valve stem 322 is less than a radial size of the valve seat body 3211, one end of the valve stem 322 is fixedly connected with the valve seat body 3211, and the other end of the valve stem 322 is the operating part for penetrating the first through hole 331 and connecting with an external operating member. The valve stem 322 is rotated by the operating member, which further drives the valve seat body 3211 and the first gasket 3212 to rotate, so as to selectively communicate the second end 312 of the valve inner flow channel 31 with one first storage member inner flow channel 13.

Optionally, the operating part of the valve stem 322 is disposed in a hexagonal structure or a quadrangular structure.

A boss 324 is disposed in the circumferential direction of the valve seat body 3211, and the boss 324 has an arc-shaped outer contour so as to reduce the friction between the circumferential direction of the valve seat body 3211 and the circumferential side wall of the groove 11 during rotation of the valve seat body 3211 relative to the groove 11.

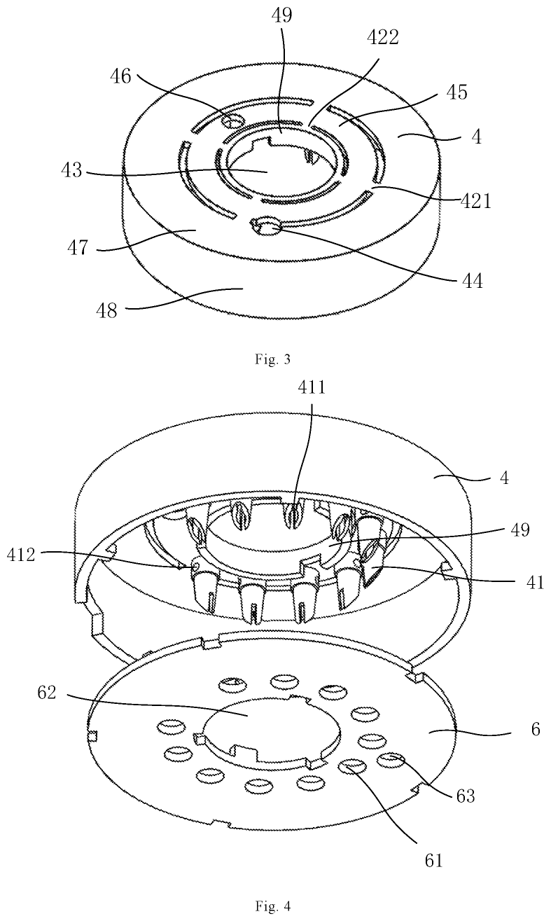

In some embodiments, as shown in FIGS. 3 to 5, the microfluidic chip further includes a sealing film, at least two storage chambers 12 include a reagent chamber 121, and the sealing film is configured to seal the reagent chamber 121. The microfluidic chip further includes a top cover 4 and a puncture needle 41. The top cover 4 is disposed at one end of the storage member 1 provided with the groove 11, the puncture needle 41 is connected to the top cover 4, and the puncture needle 41 is configured to press against the sealing film under the action of an external force to puncture the sealing film.

In some embodiments, as shown in FIGS. 3 to 5, the top cover 4 includes a first rib 421, the puncture needle 41 is connected to the first ribs 421, and the first rib 421 is configured to be disconnected under the external force, so that the puncture needle 41 is separated from the top cover 4 and pressed against the sealing film.

In some embodiments, as shown in FIGS. 3 to 5, the middle of the top cover 4 is provided with a second through hole 43, and the second through hole 43 is configured to allow the external operating member to penetrate to connect the operating part of the valve 3 for rotating the valve 3.

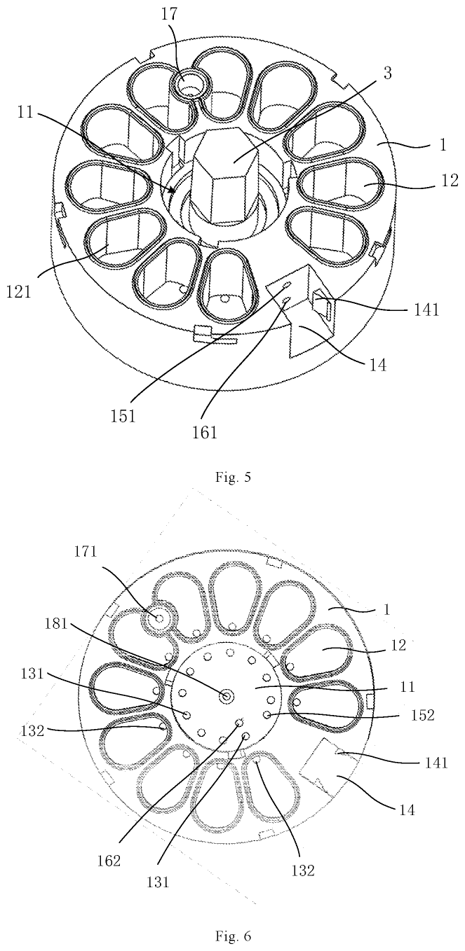

In some embodiments, as shown in FIG. 4, the puncture needle 41 is provided with a needle inner gas channel 411 therein, the part of the puncture needle 41 connected with the top cover 4 is provided with a third through hole 412, and the third through hole 412 communicates the outer part of the puncture needle 41 with the needle inner gas channel 411.

In some embodiments, as shown in FIG. 4, the microfluidic chip further includes a cover sheet 6, the cover sheet 6 is disposed in the top cover 4, and the cover sheet 6 is provided with a sixth through hole 62 allowing the external operating member to penetrate to connect the rotor 32. The cover sheet 6 is also provided with a fourth through hole 61 allowing the puncture needle 41 to penetrate. The puncture needle 41 is configured to press against the sealing film under the action of the external force, and continue to press against the sealing film after puncturing the sealing film, so that the third through hole 412 is sealed by the cover sheet 6.

As shown in FIG. 4, the puncture needle 41 includes a first needle segment and a second needle segment, and a radial size of the second needle segment is greater than a radial size of the first needle segment. The second needle segment is connected with the first rib 421. The first needle segment is configured as a sharp needle for puncturing the sealing film, and the third through hole 412 is disposed in the second needle segment.

The puncture needle is pressed against the sealing film under the action of the external force, and puncture the sealing film, so that the reagent chamber 121 is communicated with atmosphere through the needle inner gas channel 411 and the third through hole 412 in the puncture needle 41, which is convenient for subsequent reagent extraction. At this time, the first needle segment penetrate the fourth through hole 61. After the detection, the puncture needle 41 is further pressed against the sealing film under the action of the external force, and the third through hole 412 is sealed by the cover sheet 6, so as to seal the reagent chamber 121 to prevent waste liquid from flowing out.

In some embodiments, the sealing film is disposed on the cover sheet 6 to seal the reagent chamber 121.

In some other embodiments, the sealing film is directly disposed on the reagent chamber 121 to seal the reagent chamber 121.

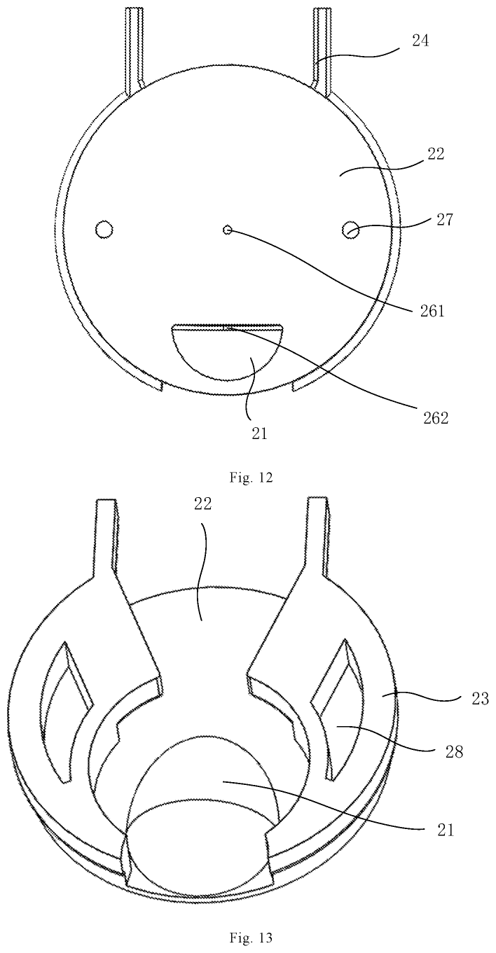

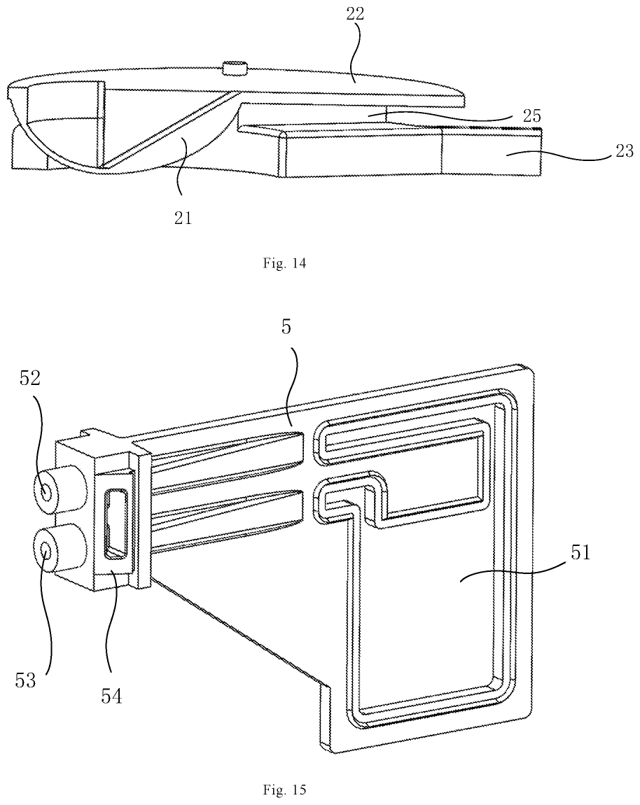

In some embodiments, as shown in FIGS. 11 to 14, the reaction chamber 21 protrudes towards one side away from the storage member 1.

In some embodiments, as shown in FIGS. 11 to 14, the reaction chamber 21 has a spherical crown structure. As a reagent reaction place for nucleic acid extraction, the reaction chamber 21 completes an extraction step in short time through the cooperation of the spherical crown cavity structure and an ultrasonic transducer.

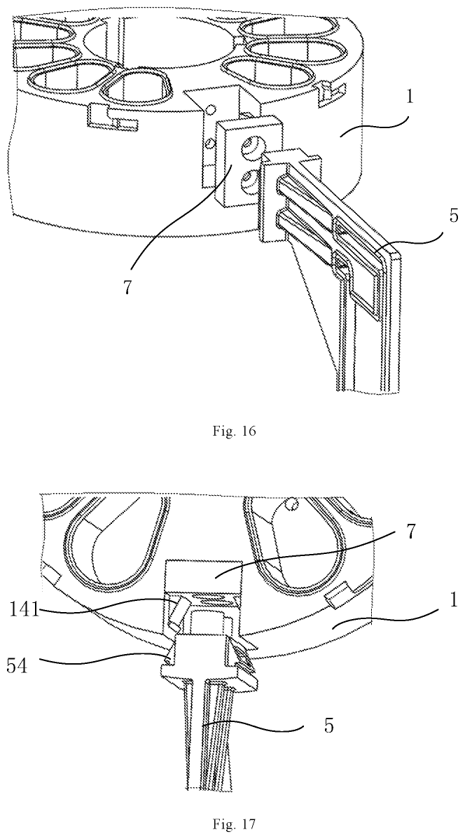

In some embodiments, as shown in FIGS. 15 to 17, the microfluidic chip further includes an amplification member 5, and the amplification member 5 is provided with an amplification chamber 51. As shown in FIGS. 5 and 6, the side part of the storage member 1 is provided with a slot 14, the slot 14 is located between two adjacent storage chambers 12, the amplification member 5 is connected with the slot 14 in an inserting way, and the valve 3 is configured to operatively communicate the reaction chamber 21 with the amplification chamber 51.

The amplification member 5 has a thin-sheet structure and a large heated surface, and is easy for sample fluorescence collection.

The amplification member 5 is designed separately, and may be connected with or separated from a main body structure of the microfluidic chip (including the storage member 1) by means of inserting and pulling, which improves versatility.

In some embodiments, as shown in FIGS. 5 to 8, the storage member 1 is provided with a second storage member inner flow channel 15, a first end 151 of the second storage member inner flow channel 15 penetrates the slot 14 and a second end 152 of the second storage member inner flow channel 15 penetrates the groove 11. As shown in FIG. 15, the amplification member 5 is provided with an amplification member inner flow channel 52 communicated with the amplification chamber 51, and the amplification member inner flow channel 52 is communicated with the first end 151 of the second storage member inner flow channel 15. The valve 3 is configured to be operatively communicated with the second end 152 of the second storage member inner flow channel 15, so as to guide a solution in the reaction chamber 21 to the amplification chamber 51 through the second storage member inner flow channel 15 and the amplification member inner flow channel 52.

In some embodiments, as shown in FIGS. 5 to 8, the storage member 1 is provided with a third storage member inner flow channel 16, a first end 161 of the third storage member inner flow channel 16 penetrates the slot 14 and a second end 162 of the third storage member inner flow channel 16 penetrates the groove 11. As shown in FIG. 15, the amplification member 5 is provided with an amplification member inner gas channel 53 communicated with the amplification chamber 51, and the amplification member inner gas channel 53 is communicated with the first end 161 of the third storage member inner flow channel 16. The valve 3 is configured to be operatively communicated with the second end 162 of the third storage member inner flow channel 16, to guide gas in the amplification chamber 51 to one storage chamber 12 through the amplification member inner gas channel 53 and the third storage member inner flow channel 16, so as to keep air pressure balance in the amplification chamber 51. If there are too much sample to be detected and the amplification chamber 51 cannot fit, excessive liquid in the amplification chamber 51 may also be discharged to the storage chamber 12 through the above communicated gas channel and flow channel, to avoid leakage and contamination. The amplification member 5 includes a main body part and an inserting and pulling part, the amplification chamber 51 is disposed in the main body part, and the inserting and pulling part is matched and connected with the slot 14 in an inserting and pulling way.

Both the amplification member inner flow channel 52 and the amplification member inner gas channel 53 are communicated with the amplification chamber 51, and some parts of the amplification member inner flow channel 52 and the amplification member inner gas channel 53 are located in the inserting and pulling part.

While the valve 3 is communicated with the second end 152 of the second storage member inner flow channel 15 to introduce the solution in the reaction chamber 21 to the amplification chamber 51 through the second storage member inner flow channel 15 and the amplification member inner flow channel 52, the valve 3 is also communicated with the second end 162 of the third storage member inner flow channel 16 to introduce the gas in the amplification chamber 51 to one storage chamber 12 through the amplification member inner gas channel 53 and the third storage member inner flow channel 16. Optionally, the storage chamber 12 is adjacent to the slot 14.

In some embodiments, as shown in FIGS. 9 and 10, the valve 3 is provided with the valve inner flow channel 31 communicated with the reaction chamber 21 therein. The valve 3 is also provided with a valve inner gas channel 34 therein, and the valve 3 is configured to operatively communicate the valve inner flow channel 31 with the reaction chamber 21 and the amplification chamber 51, and communicate the valve inner gas channel 34 with the amplification chamber 51 and one storage chamber 12.

In some embodiments, as shown in FIGS. 5 to 7, the storage member 1 is provided with a storage member inner gas channel 17, and the storage member inner gas channel 17 is communicated with the reaction chamber 21 and is configured to be communicated with an external air pump. The air pump provides a suction force for introducing the solution in the storage chamber 12 into the reaction chamber 21 through the valve 3, or the air pump provides a blowing force for introducing the solution in the reaction chamber 21 into the storage chamber 12 through the valve 3.

In some embodiments, as shown in FIGS. 5 to 7, a first end 171 of the storage member inner gas channel 17 penetrates one end of the storage member 1 provided with the groove 11, and the first end 171 of the storage member inner gas channel 17 is located between two adjacent storage chambers 12.

In some embodiments, as shown in FIG. 1, the top cover 4 is fixedly disposed at one end of the storage member 1 provided with the groove 11, and the base 2 is fixedly disposed at one end of the storage member 1 away from the top cover 4.

In some embodiments, as shown in FIG. 2, the storage member 1 has a cylindrical structure, a cover surface of the top cover 4 covering the storage member 1 is circular, the surface of the base 2 connected with the storage member 1 is circular, and the cover sheet 6 is circular. The groove 11 disposed in the storage member 1 is a cylindrical groove. The base 321 and the first gasket 3212 of the rotor 32 of the valve 3 are circular.

Some specific embodiments of the microfluidic chip will be described in detail with reference to FIGS. 1 to 17.

As shown in FIGS. 1 and 2, the microfluidic chip includes the storage member 1, the base 2, the valve 3, the top cover 4, the amplification member 5 and the cover sheet 6.

As shown in FIGS. 1 and 2, the top cover 4 is fixed on the top of the storage member 1, and encloses part of the top of the storage member 1 therein, and the cover sheet 6 is disposed between the top cover 4 and the top of the storage member 1. The base 2 is fixedly disposed at the bottom of the storage member 1. The middle position of the top of the storage member 1 is provided with the groove 11 concave to the bottom, the valve 3 is disposed in the groove 11, the operating part of the valve 3 extends out of the groove 11 to the top cover 4, and the top cover 4 is provided with a through hole allowing the operating part of the valve 3 to penetrate, or an external operating member extends into the through hole to be connected with the operating part of the valve 3, so as to operate the valve 3 to act. The amplification member 5 is disposed at the side part of the storage member 1 in an inserting and pulling way, and the side part of the top cover 4 is provided with a notch avoiding the amplification member 5.

As shown in FIGS. 2 to 4, the top cover 4 includes a circular cover plate 47, the middle of the cover plate 47 is provided with a second through hole 43 for the operating part of the valve 3 to penetrate, or an external operating member extends into the second through hole 43 to be connected with the operating part of the valve 3. A circle of circumferential side wall 48 extending to the storage member 1 is disposed in the circumferential direction of the cover plate 47, and the circumferential side wall 48 of the top cover 4 encloses part of the top of the storage member 1 therein. The circumferential side wall 48 of the top cover 4 is provided with a clamping block, the top of the storage member 1 is provided with a clamping groove, and the top cover 4 and the storage member 1 are fixedly connected through the structures of the clamping block and the clamping groove.

The cover plate 47 of the top cover 4 is provided with a sample adding port 46, the sample adding port 46 corresponds to the position of one of the plurality of storage chambers 12, this storage chamber 12 serves as a sample adding chamber, and the sample to be detected is added into the sample adding chamber through the sample adding port 46.

The cover plate 47 of the top cover 4 is also provided with a fifth through hole 44, the fifth through hole 44 is used to be communicated with the storage member inner gas channel 17 of the storage member 1, the storage member inner gas channel 17 is communicated with the reaction chamber 21, and gas in the reaction chamber 21 is communicated with the outside through the storage member inner gas channel 17 and the fifth through hole 44. The fifth through hole 44 may serve as a pump interface and be connected with the air pump, and a suction force is provided by the air pump, so that the solution in the storage chamber 12 is introduced into the reaction chamber 21 through the valve 3; and a blowing force is provided by the air pump, so that the solution in the reaction 21 is introduced into the storage chamber 12 through the valve 3.

The storage member 1 is provided with a plurality of storage chambers 12 around the groove 11. Therefore, correspondingly, a plurality of puncture needles 41 are connected on the cover plate 47 of the top cover 4, all puncture needles 41 are disposed at intervals around a center line of the groove 11, and each puncture needle 41 corresponds to one storage chamber 12. Each puncture needle 41 may be connected to an annular member 45, the outer edge of the annular member 45 is connected to the cover plate of the top cover 4 through a plurality of first ribs 421, and the inner edge of the annular member 45 may be connected to a cylindrical member 49 through a plurality of second ribs 422.

The puncture needle 41 has a hollow structure, that is, is provided with a needle inner gas channel 411 therein, the puncture needle 41 is also provided with a third through hole 412, and the third through hole 412 communicates the needle inner gas channel 411 with external atmosphere. The puncture needle 41 includes a first needle segment and a second needle segment, and a radial size of the second needle segment is greater than a radial size of the first needle segment. The second needle segment is connected to the annular member 45, the first needle segment is configured as a sharp needle for puncturing the sealing film, and the third through hole 412 is disposed in the second needle segment.

When the microfluidic chip is used, pressure is applied to the annular member 45 on the top cover 4 to break the first ribs 421, the annular member 45 drives all puncture needles 41 to be separated from the cover plate 47, and to press against the sealing films on the storage chamber 12, the puncture needles 41 puncture the sealing films, and the cylindrical member 49 abuts against the circumferential side wall of the groove 11 to prevent the puncture needles 41 from excessively moving down. At this time, the gas in the storage chambers 12 is communicated with the atmosphere through the needle inner gas channels 411 and the third through holes 412. After the extraction step is completed, the external force is continuously applied to the annular member 45 and all puncture needles 41, the second ribs 422 are broken, the annular member 45 is separated from the cylindrical member 49, the cylindrical member 49 no longer interferes with downward movement of the puncture needles 41, the annular member 45 and all puncture needles 41 are further pressed against the sealing films under the action of the external force, and the second needle segments are in interference fit with the fourth through holes 61. The second needle segments are matched with the cover sheet 6 to block the third through holes 412 in the second needle segments, so as to seal the storage chambers 12, which avoids leakage of the waste liquid in the storage chambers 12.

The cover sheet 6 is circular, and is provided with the fourth through holes 61, a sixth through hole 62 and a seventh through hole 63 in the middle. The sixth through hole 62 is aligned with the second through hole 43 in the cover plate 47, and is used to be penetrated by the operating part of the valve 3, or an external operating member is allowed to extend into the sixth through hole 62 to be connected with the operating part of the valve 3. There are a plurality of fourth through holes 61, and each fourth through hole 61 corresponds to one puncture needle 41. The seventh through hole 63 is aligned with the fifth through hole 44 in the top cover 4 to be communicated with the storage member inner gas channel 17.

The radial size of the second needle segment of the puncture needle 41 is greater than the radial size of the first needle segment. When using the microfluidic chip, the first needle segment puncture the sealing film through the fourth through hole 61, and the second needle segment and the third through hole 412 are located above the cover sheet 6. After the extraction step is completed, the annular member 45 and each puncture needle 41 are further pressed against the sealing film under the action of the external force, and the second needle segment is in interference fit with the fourth through hole 61. The second needle segment is matched with the cover sheet 6 to block the third through hole 412, so as to seal the storage chamber 12, which avoids leakage of the waste liquid in the storage chamber 12.

In summary, the puncture needles 41 on the top cover 4 are used to puncture the sealing films on the storage chamber 12 and enable the storage chamber 12 to be communicated with the atmosphere. The cover sheet 6 is used to be matched with the puncture needles 41 of the top cover 4 to seal the storage chambers 12 after detection.

As shown in FIGS. 5 to 8, the storage member 1 is cylindrical, and is provided with the groove 11 concave to the bottom in the middle of the top end, and the plurality of storage chambers 12 are disposed around the groove 11. The storage chambers 12 may serve as a sample adding chamber and reagent chambers 121. In the present embodiment, the plurality of storage chambers 12 include one sample adding chamber and a plurality of reagent chambers 121, the sample adding chamber is used for adding the sample to be detected, and reagents for biochemical reactions are stored in the reagent chambers 121. The upper surfaces of the reagent chambers 121 are sealed with the sealing films, and the lower surfaces are sealed. The second ends 132 of the first storage member inner flow channels 13 are communicated with the reagent chambers 121 through the lowest positions of the reagent chambers 121. An appropriate bonding way is selected for the reagent chambers 121 as required, so as to ensure that the reagents are hermetically packaged and convenient for transportation and storage. The storage chamber 12 has an oval cross section. The cross section of the storage chamber 12 is narrow close to the center line of the groove 11 and wide away from the center line of the groove 11. The size and distribution of the storage chambers 12 may be adjusted as required.

The storage member 1 is provided with the storage member inner gas channel 17 therein, and the first end of the storage member inner gas channel 17 is located between two adjacent storage chambers 12. The storage member inner gas channel 17 is communicated with the reaction chamber 21. The side part of the storage member 1 is provided with a slot 14 for inserting the amplification member 5.

The storage member 1 is provided with at least two first storage member inner flow channels 13 therein, and each first storage member inner flow channel 13 is correspondingly communicated with one storage chamber 12. The first end 131 of each first storage member inner flow channel 13 penetrates the bottom wall of the groove 11 for being communicated with the valve inner flow channel 31 of the valve 3. The second end 132 of each first storage member inner flow channel 13 is communicated with the storage chamber 12 through one side of the storage chamber 12 adjacent to the base 2, and the second end 132 of the first storage member inner flow channel 13 is communicated with the lowest part of the storage chamber 12 to avoid reagent residue. The second ends 132 of the first storage member inner flow channels 13 are communicated with the positions of the storage chambers 12 closest to the groove 11, so as to shorten a communication distance with the valve 3 and improve detection efficiency.

The storage member 1 is provided with a fourth storage member inner flow channel 18 therein, a first end 181 of the fourth storage member inner flow channel 18 penetrates the bottom wall of the groove 11 and is located in the middle of the groove 11, and the first end 181 of the fourth storage member inner flow channel 18 is used for being communicated with the valve inner flow channel 31 of the valve 3. A second end of the fourth storage member inner flow channel 18 is communicated with the reaction chamber 21.

The storage member 1 is provided with the second storage member inner flow channel 15, a first end 151 of the second storage member inner flow channel 15 penetrates the slot 14 for being communicated with the amplification member inner flow channel 52, and a second end 152 of the second storage member inner flow channel 15 penetrates the groove 11 for being communicated with the valve inner flow channel 31 of the valve 3.

The storage member 1 is provided with the third storage member inner flow channel 16, and the first end 161 of the third storage member inner flow channel 16 penetrates the slot 14 for being communicated with the amplification member inner gas channel 53. The second end 162 of the third storage member inner flow channel 16 penetrates the groove 11 for being communicated with the valve inner gas channel 34 of the valve 3.

The slot 14 is provided with a first buckle 141 therein for being matched and connected with a second buckle 54 on the amplification member 5.

As shown in FIGS. 9 and 10, the valve 3 is used to control the closure of a liquid path and be communicated with each chamber. The valve 3 includes the rotor 32 and the valve cover 33.

The valve cover 33 is used for connecting the circumferential side wall of the groove 11, the valve cover 33 is provided with the first through hole 331, the operating part of the rotor 32 penetrates the first through hole 331, and the operating part of the rotor 32 is configured to be connected with an external operating member. The valve cover 33 is provided with a plurality of connecting blocks connected with the circumferential side wall of the groove 11.

The rotor 32 is rotatably disposed in the groove 11. The rotor 21 includes the valve seat body 3211, the valve stem 322 and the first gasket 3212. The first gasket 3212 and the bottom of the valve seat body 3211 are consistent in shape, and are both circular. The valve seat body 3211 and the first gasket 3212 are fixedly disposed. The valve inner flow channel 31 is formed in a combined structure of the valve seat body 3211 and the first gasket 3212.

The radial size of the valve stem 322 is less than the radial size of the valve seat body 3211, one end of the valve stem 322 is fixedly connected with the valve seat body 3211, and the other end of the valve stem 322 is the operating part for penetrating the first through hole 331 and being connected with an external operating member.

The valve 3 is provided with the valve inner flow channel 31 and the valve inner gas channel 34 therein.

The first end 311 of the valve inner flow channel 31 is located in the middle of the valve 3, and is aligned and communicated with the first end 181 of the fourth storage member inner flow channel 18 in the groove 11. The valve inner flow channel 31 is always communicated with the reaction chamber 21 through the fourth storage member inner flow channel 18, the second end 312 of the valve inner flow channel 31 is selectively communicated with any one first storage member inner flow channel 13 or the second storage member inner flow channel during rotation along with the rotor 32, and the second end 312 of the valve inner flow channel 31 is close to the outer edge of the valve 3.

When the second end 312 of the valve inner flow channel 31 is communicated with the second storage member inner flow channel 15, the first end of the valve inner gas channel 34 is communicated with the second end 162 of the third storage member inner flow channel 16, the second end of the valve inner gas channel 34 is communicated with the first end 131 of the first storage member inner flow channel 13, and the second end 132 of the first storage member inner flow channel 13 is communicated with one storage chamber 12.

The operating part of the valve stem 322 is connected through the external operating member, and the valve stem 322 is rotated, which further drives the valve seat body 3211 and the first gasket 3212 to rotate, so that the second end 312 of the valve inner flow channel 31 is selectively communicated with one first storage member inner flow channel 13 or the second storage member inner flow channel 15, thereby completing the liquid flow transfer during the detection process.

Optionally, the operating part of the valve stem 322 is constructed in a hexagonal structure.

The circumferential direction of the valve seat body 3211 is provided with the boss 324, and the boss 324 has an arc-shaped outer contour to reduce the friction between the circumferential direction of the valve seat body 3211 and the circumferential side wall of the groove 11 during rotation of the valve seat body 3211 relative to the groove 11.

As shown in FIGS. 11 to 14, the base 2 includes a chassis 22, a supporting member 23 and a positioning member 24.

The surface of the chassis 22 is circular, the chassis 22 is provided with a positioning lug 27, and the positioning lug 27 is used for connecting the storage member 1.

The supporting member 23 is disposed below the chassis 22 for supporting the chassis 22 and the whole microfluidic chip. As a supporting structure of the microfluidic chip, the supporting member 23 enables the microfluidic chip to be stably placed. The bottom of the supporting member 23 is also provided with a positioning groove 28, and the positioning groove 28 is used to be matched with a placing platform on a detection device to complete initial positioning of the microfluidic chip. A clamping groove 25 is formed between the supporting member 23 and the chassis 22. During the process of pushing the microfluidic chip into the detection device, the clamping groove 25 is used to be matched and positioned with the structure on the detection device to further fix the microfluidic chip, thereby avoiding detection errors caused by movement of the microfluidic chip in the detection process and improve detection consistency.

The reaction chamber 21 is disposed at the bottom of the chassis 22, protrudes downward, and has a spherical crown structure, and such a structure may be coupled with an ultrasonic head to achieve resonance quickly, and assists in sample lysis and magnetic bead mixing. The chassis 22 is provided with a chassis inner flow channel communicated with the reaction chamber 21 therein, a first end 261 of the chassis inner flow channel is located in the middle of the chassis 22, and a second end 262 of the chassis inner flow channel is communicated with the reaction chamber 21. The first end 261 of the chassis inner flow channel is communicated with the fourth storage member inner flow channel 18 and is aligned with the first end 311 of the valve inner flow channel 31, so that the valve inner flow channel 31 is always communicated with the reaction chamber 21. The second end 262 of the chassis inner flow channel is communicated with the reaction chamber 21 through the lowest part of the reaction chamber 21, so as to avoid the incapability of completely discharging the reagents due to the formation of a dead zone.

The positioning member 24 is disposed on the support member 23 for positioning when the microfluidic chip is installed on the detection device.

The above top cover 4 is fixedly disposed at one end of the storage member 1 provided with the groove 11, the base 2 is fixedly disposed at one end of the storage member 1 away from the top cover 4, and the valve 3 is disposed in the groove 11. The top cover 4, the storage member 1, the base 2 and the valve 3 form the main body structure of the microfluidic chip.

As shown in FIGS. 15 to 17, the amplification member 5 has a sheet structure, which is used to realize rapid temperature-rising and temperature-lowering amplification. The amplification member 5 is connected and detached with the slot 14 of the storage member 1 by plugging and unplugging. The amplification member 5 may be separated from the main body structure of microfluidic chip, and may be produced and bonded with a material different from the main body structure.

The amplification chamber 51 is disposed in the amplification member 5, and the amplification chamber 51 is in the shape of a sheet, and thus can have a larger contact surface with a heat source and better thermal conductivity. The amplification member 5 is provided with the amplification member inner flow channel 52 communicated with the amplification chamber 51, and the amplification member inner flow channel 52 is communicated with the first end 151 of the second storage member inner flow channel 15. The amplification member 5 is provided with the amplification member inner gas channel 53 communicated with the amplification chamber 51, and the amplification member inner gas channel 53 is communicated with the first end 161 of the third storage member inner flow channel 16.

The joint between the main body structure of the microfluidic chip and the amplification member 5 may be fixed with a soft rubber second gasket 7 by means of secondary injection molding or adhesion, so as to ensure air tightness of the amplification member inner flow channel 52 and the amplification member inner gas channel 53 at the joint.

The cross section of the first buckle 141 disposed in the slot 14 and the cross section of the second buckle 54 disposed on the amplification member 5 may be both triangular. After the amplification member 5 is inserted into the slot 14, the first buckle 141 and the second buckle 54 are mutually limited to prevent the amplification member 5 from being pulled out of the slot 14.

Some embodiments also provide a microfluidic chip detection system, which includes a detection device and the above microfluidic chip. The detection device includes an operating table for accommodating the microfluidic chip and an operating member for operating the valve 3.

The microfluidic chip detection system according to the embodiment of the present disclosure has low requirements on operators, and can start the detection process including extraction and amplification by only adding the sample to be detected, putting the microfluidic chip into the detection device, and clicking a start button.

The following describes a detection flow of the microfluidic chip:

The microfluidic chip loaded with corresponding reagents is selected according to detection items, and the sample to be detected is injected into the sample chamber of the microfluidic chip, that is, the preliminary preparation work is completed.

The operator pays attention to the base 2 of the microfluidic chip and a positioning structure corresponding to the detection device, and places the base 2 of the microfluidic chip flat on a tray of the detection device to complete initial positioning. After clicking the start button, a tray enters a working area of the detection device, and the clamping groove 25 of the base 2 is matched with the positioning structure on the detection device to clamp and fix the microfluidic chip.

At the beginning of the detection process, the air pump is connected with an air pump interface in the microfluidic chip, the puncture needles 41 on the top cover 4 of the microfluidic chip are pressed downwards, and the first ribs 421 are broken, so that the puncture needles 41 are separated from the top cover 4, the sealing films on the storage chambers 12 are punctured, and the storage chambers 12 are communicated with the air through the needle inner gas channels 411 and the third through holes 412 in the puncture needles 41, so as to prepare for release of the reagents.

The valve 3 is rotated to be respectively connected with one storage chamber 12 and the reaction chamber 21, and a power source is provided by the external air pump, so that the reagent extraction required by each extraction step is completed in turn.

In the present embodiment, a magnetic bead method is used for nucleic acid extraction. After the reagents in the extraction storage chamber 12 enter the reaction chamber 21, the ultrasonic head will be coupled with the reaction chamber 21 for resonance, the spherical crown structure of the reaction chamber 21 can provide a better supporting force and avoid wall surface deformation during the ultrasonic process, and at the same time, the contact surface has better consistency. Under the action of ultrasound, the wall surface vibrates to drive the reagents and magnetic beads in the reaction chamber 21 to agitate, which can complete auxiliary lysis of the sample and uniform mixing of the magnetic beads within a few seconds. The waste liquid after reaction will be transferred back into the storage chamber 12 from the reaction chamber 21, and then sealed by rotating the valve 3.

After the reagents are sequentially extracted for reaction in the reaction chamber 21, the purified extracted product is finally obtained, the purified extracted product is transferred to the amplification chamber 51, and then the amplification chamber 51 is sealed by rotating the valve 3, waiting for rapid amplification and multiflow channel optical detection of the sample by an amplification module of the detection device.

After the detection is completed, a pressing module in the detection device will act on the puncture needles 41 on the top cover 4 of the microfluidic chip again, the pressing force will break the second ribs 422, and the puncture needles 41 will continue to move downwards. The second needle segments of the puncture needles 41 form an interference fit with the cover sheet 6, and the cover sheet 6 will cover the third through holes 412 in the second needle segments, so as to isolate the storage chambers 12 from the atmosphere and avoid the leakage of the reaction waste liquid in the storage chambers 12.

At this point, the detection flow of the microfluidic chip has been completely finished, and a “chamber exiting” button may be clicked to withdraw the pressure, take out the microfluidic chip and start the detection of the next group.

The flow channels in the present disclosure may be used for liquid transmission and gas transmission. Similarly, the gas channels may be used for gas transmission and liquid transmission.

Based on the above respective embodiments of the present disclosure, the technical features of one of the embodiments may be beneficially combined with one or more of other embodiments without explicit negation or conflict.

Finally, it should be noted that the above embodiments are only used for illustrating rather than limiting the technical solutions of the present disclosure; although the present disclosure has been described in detail with reference to the preferred embodiments, those of ordinary skill in the art should understand that modifications can still be made to the specific embodiments of the present disclosure or equivalent substitutions can be made to part of technical features; and without departing from the spirit of the technical solutions of the present disclosure, the modifications and equivalent substitutions should be included in the scope of the technical solutions claimed in the present disclosure.

1. A microfluidic chip, comprising:
a storage member provided with a groove therein, at least two storage chambers being disposed around the groove;
a base disposed at one end of the storage member away from the groove, a reaction chamber being disposed on the base; and
a valve disposed in the groove, the valve being configured to operatively communicate any one of the at least two storage chambers with the reaction chamber.

2. The microfluidic chip according to claim 1, wherein at least two first storage member inner flow channels are disposed in the storage member, each first storage member inner flow channel is correspondingly communicated with one storage chamber, a valve inner flow channel communicated with the reaction chamber is disposed in the valve, and the valve is configured to operatively communicate the valve inner flow channel with any first storage member inner flow channel.

3. The microfluidic chip according to claim 2, wherein a first end of each first storage member inner flow channel penetrates a bottom wall of the groove, the valve is configured to operatively communicate the valve inner flow channel with the first end of the first storage member inner flow channel, and a second end of each first storage member inner flow channel is communicated with the storage chamber via one side of the storage chamber adjacent to the base.

4. The microfluidic chip according to claim 3, wherein the second ends of the first storage member inner flow channels are communicated with parts of the storage chambers at the lowest positions.

5. The microfluidic chip according to claim 3, wherein both a first end and a second end of the valve inner flow channel penetrate one end of the valve adjacent to the bottom wall of the groove, the first end of the valve inner flow channel is communicated with the reaction chamber, the second end of the valve inner flow channel is operatively communicated with any first storage member inner flow channel, the first end of the valve inner flow channel is located in a middle of the valve, and the second end of the valve inner flow channel is close to an outer edge of the valve.

6. The microfluidic chip according to claim 1, wherein the valve comprises:
a rotor rotatably disposed in the groove, the rotor comprises a valve seat and a valve stem, and the valve stem being connected with the valve seat; and
a valve cover connected with a circumferential side wall of the groove and abutting against the valve seat to limit the valve seat between the valve cover and the bottom wall of the groove, the valve cover being provided with a first through hole, an operating part of the valve stem penetrating the first through hole, and the operating part of the valve stem being configured to be connected with an external operating member.

7. (canceled)

8. The microfluidic chip according to claim 1, further comprising: a sealing film, the at least two storage chambers comprise a reagent chamber, the sealing film is configured to seal the reagent chamber, the microfluidic chip further comprises a top cover and a puncture needle, the top cover is disposed at one end of the storage member provided with the groove, the puncture needle is connected to the top cover, and the puncture needle is configured to press against the sealing film under the action of an external force to puncture the sealing film.

9. The microfluidic chip according to claim 8, wherein the top cover comprises a first rib, the puncture needle is connected to the first rib, and the first rib is configured to be disconnected under the action of the external force, so that the puncture needle is separated from the top cover and pressed against the sealing film.

10. The microfluidic chip according to claim 8, wherein a middle of the top cover is provided with a second through hole, and the second through hole is configured to allow the external operating member to penetrate to operate the valve.

11. The microfluidic chip according to claim 8, wherein the puncture needle is provided with a needle inner gas channel therein, and a third through hole communicating an outer part of the puncture needle with the needle inner gas channel is disposed near a part of the puncture needle connected with the top cover.

12. The microfluidic chip according to claim 11, further comprising a cover sheet, the cover sheet is disposed in the top cover, the cover sheet is provided with a fourth through hole allowing the puncture needle to penetrate, and the puncture needle is configured to press against the sealing film under the action of the external force, and continue to press against the sealing film after puncturing the sealing film, so that the third through hole is sealed by the cover sheet.

13. The microfluidic chip according to claim 1, wherein the reaction chamber protrudes towards one side away from the storage member.

14. (canceled)

15. The microfluidic chip according to claim 1, further comprising an amplification member, the amplification member is provided with an amplification chamber, a side part of the storage member is provided with a slot, the slot is located between two adjacent storage chambers, the amplification member is connected with the slot in an inserting way, and the valve is configured to operatively communicate the reaction chamber with the amplification chamber.

16. The microfluidic chip according to claim 15, wherein the storage member is provided with a second storage member inner flow channel, a first end of the second storage member inner flow channel penetrates the slot, a second end of the second storage member inner flow channel penetrates the groove, the amplification member is provided with an amplification member inner flow channel communicated with the amplification chamber, the amplification member inner flow channel is communicated with the first end of the second storage member inner flow channel, and the valve is configured to be operatively communicated with the second end of the second storage member inner flow channel to guide a solution in the reaction chamber to the amplification chamber through the second storage member inner flow channel and the amplification member inner flow channel.

17. The microfluidic chip according to claim 16, wherein the storage member is provided with a third storage member inner flow channel, a first end of the third storage member inner flow channel penetrates the slot, a second end of the third storage member inner flow channel penetrates the groove, the amplification member is provided with an amplification member inner gas channel communicated with the amplification chamber, the amplification member inner gas channel is communicated with the first end of the third storage member inner flow channel, and the valve is configured to be operatively communicated with the second end of the third storage member inner flow channel to guide gas in the amplification chamber to one storage chamber through the amplification member inner gas channel and the third storage member inner flow channel.

18. The microfluidic chip according to claim 15, wherein the valve inner flow channel communicated with the reaction chamber is disposed in the valve, a valve inner gas channel is also disposed in the valve, and the valve is configured to operatively communicate the valve inner flow channel with the reaction chamber and the amplification chamber, and communicate the valve inner gas channel with the amplification chamber and one storage chamber.

19. The microfluidic chip according to claim 1, wherein the storage member is provided with a storage member inner gas channel, the storage member inner gas channel is communicated with the reaction chamber, and the storage member inner gas channel is configured to be communicated with an external air pump.

20. The microfluidic chip according to claim 19, wherein a first end of the storage member inner gas channel penetrates one end of the storage member provided with the groove, and the first end of the storage member inner gas channel is located between two adjacent storage chambers.

21. The microfluidic chip according to claim 8, wherein the top cover is fixedly disposed at one end of the storage member provided with the groove, and the base is fixedly disposed at one end of the storage member away from the top cover.

22. A microfluidic chip detection system, comprising a detection device and the microfluidic chip according to claim 1, wherein the detection device comprises an operating table for accommodating the microfluidic chip and an operating member for operating the valve.
